(19) United States
(12) Patent Application Publication
(10) Pub. No.: US 2003/0160394 A1
(43) Pub. Date: Aug. 28, 2003

(54) Valve stem seal on combustion engines

(75) Inventor: Massimo Martelli, Bricherasio (IT)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/367,352

(22) Filed: Feb. 14, 2003

(30) Foreign Application Priority Data
Feb. 25, 2002 (DE) DE 102 07 818.1

(51) Int. Cl. F16J 15/16

(52) U.S. Cl. 277/500

(57) ABSTRACT

A valve stem seal on combustion engines, including a sealing element which is made of a polymeric material and contacts the valve stem radially and the valve stem guide axially, and further including a sleeve-shaped retaining member which holds the sealing element. The retaining member (2) has a polyhedron-like shape in cross-section featuring wall sections (4) contacting the outer wall (5) of the valve stem guide (6).

Priority to German Patent Application No. 102 07 818.1-13, filed Feb. 25, 2002 and hereby incorporated by reference herein, is claimed.

### BACKGROUND INFORMATION

The present invention relates to a valve stem seal on combustion engines, including a sealing element which is made of a polymeric material and contacts the valve stem radially and the valve stem guide axially, and further including a sleeve-shaped retaining member which holds the sealing element.

The seal present on valve stems is intended, on one hand, to prevent oil from reaching the valve seat, but on the other hand also to supply sufficient oil to the valve stem for the lubrication thereof in order to prevent excessive wear of the valve stem and of the valve stem guide. A further aim is to design the valve stem seal in as inexpensive a manner as possible while at the same time ensuring a long service life.

A valve stem seal which provides good sealing combined with ease of manufacture is known from German Patent Application No. 199 49 248 A1. This valve stem seal can be used for different application purposes.

Another possibility is shown in German Patent Application No. DE 197 36 321 A1, in which the valve stem seal is composed of a sleeve-shaped retaining member which supports a sealing lip and axially projects over the sealing lip and which is at the same time used to secure the seal to the valve stem guide. To this end, the retaining member is slid onto the lateral surface of the valve stem guide with its projecting sleeve section and pressed into an annular groove in the lateral surface of the valve stem guide with at least one radial projection which is inwardly notched out of the middle region of the sleeve section. The sealing lip of the valve stem seal contacts the valve stem while an axially projecting annular sealing lip is preloaded against the end face of the valve stem guide. A valve stem seal of that kind requires high manufacturing accuracy and is complicated to install.

Another solution where the sealing lip is held by sleeve-shaped retainer is shown in European Patent Application No. EP 0 544 458 A1. There, two telescoped shells are shown which allow adjustment of the guide height of the sealing lip. The telescoped design of the two shells indeed allows height adjustment, but the fixing in place of the seal, which is desired during operation, is hardly achievable. This document does not specify any measures fulfilling this purpose either.

### BRIEF SUMMARY OF THE INVENTION

An object of the present invention is to devise a valve stem seal which is easy to manufacture, requires as small an amount of material as possible, provides a good seal, and which is easy to mount on the valve stem guide.

For a valve stem seal of the type mentioned at the outset, the set objective is achieved according to the present invention in that the retaining member is designed as a polyhedron featuring wall sections contacting the outer wall of the valve stem guide. Such a valve stem seal can be manufactured with a minimum of polymeric material and also of metal. Moreover, it is easy to manufacture and install.

The retaining member is designed such that predetermined wall sections contact the outer wall of the valve stem guide under spring load, thus fixing the seal in place on the valve stem guide.

In many application cases, it is sufficient if the retaining member has the form of a triangle when viewed in cross-section. Depending on the field of application, it is possible to increase the number of wall sections contacting the outer wall of the valve stem guide. A higher number of these wall sections results in a stronger fixation of the retaining member on the valve stem guide.

Preferably, the wall sections of the retaining member that contact the outer wall of the valve stem guide have a planar shape; then, they contact the valve stem guide along a line contact. However, it is also possible to widen the contact area by providing the wall sections of the retaining member with curvatures which are matched to the outside diameter of the valve stem guide.

The wall sections of the retaining member that are located between the planar wall sections have a cylindrical shape whose center axis coincides with the axis of the valve stem. This reinforces the stability of individual parts relative to each other.

In the simplest embodiment, the cylindrical wall sections of the retaining member can run parallel to the valve stem axis over their entire length. However, in order to spring-load the planar wall sections of the retaining member against the valve stem guide as well as possible, it is convenient for the planar wall sections to have a clip-like section, when viewed in cross-section, which reinforces the spring loading of the planar wall sections.

Thus, the present invention is a valve stem seal which can be fixed in place on the valve stem guide thanks to the metal part provided with multiple planar, flexible surfaces, the metal part having n (planar) surfaces forming n contacts with the outside diameter of the valve stem guide (n≧3). Due to the resulting radial force, the retaining member, which is polygon-like when viewed in cross-section, overcomes the axial force and vibration resulting from valve stem vibrations to prevent “pop off”, and also overpowers any positive pressure generated under the sealing lip. The properties of the flexible metal part make it possible to compensate for an increased tolerance range of the outside diameter of the valve guide which, in some cases, reduces surface production requirements for the outside diameters of valve guides. Thus, the retaining member becomes a functional feature of the valve stem seal. In this context, the dynamic region is not affected. The static region is limited to a static lip at the upper surface of the valve guide, the required quantity of elastomer being reduced.

### BRIEF DESCRIPTION OF THE DRAWINGS

In the following, the present invention is explained in greater detail in the light of an exemplary embodiment shown in the drawing, in which:

FIG. 1 shows a view of the valve stem seal along line B-B of FIG. 2; and

FIG. 2 shows a section through the valve stem seal along line A-A of FIG. 1.

### DETAILED DESCRIPTION

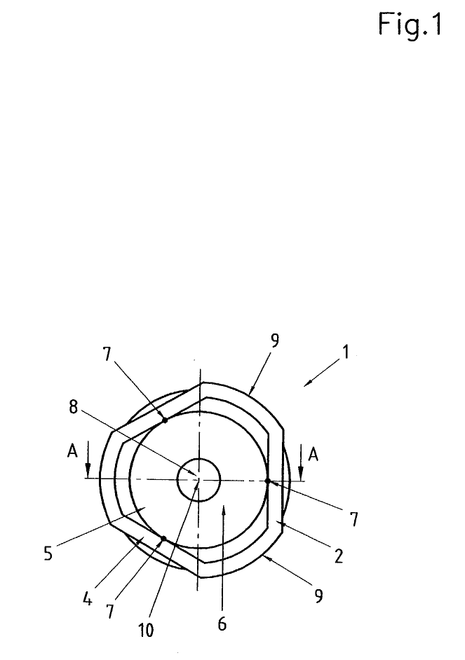

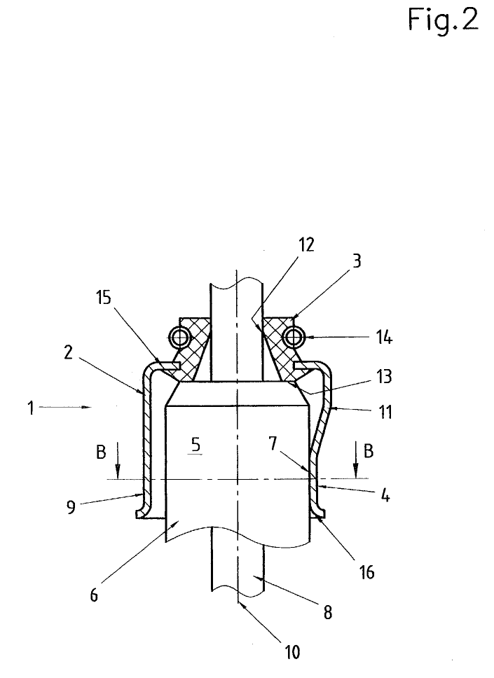

In FIG. 1, valve stem seal 1 is depicted in a view along line of intersection B-B from FIG. 2. FIG. 1 depicts an example of retaining member 2 featuring three wall sections 4. However, the number of wall sections 4 can be increased, as described above. There can be seen a triangle-shaped form retaining member 2 for sealing element 3. Retaining member 2 contacts outer wall 5 of valve stem guide 6 with planar-shaped wall sections 4; to be more precise, a linear contact is given here at points 7. Valve stem 8 is located in valve stem guide 6. Wall sections 4 are pressed against outside wall 5 of the valve stem guide under spring force. Planar wall sections 4, 11 (FIG. 2) of retaining member 2 are interconnected by cylindrical wall sections 9. The center axis of these wall sections coincides with axis 10 of valve stem 8.

In FIG. 2, valve stem seal 1 is shown in a cross-section along line of intersection A-A of FIG. 1. Valve stem 8 is surrounded by valve stem guide 6. Retaining member 2, which is composed of planar 4 and cylindrical wall sections 9, is placed on valve stem guide 6. Cylindrical wall sections 9 run parallel to valve stem axis 10. Planar wall sections 4 have line contact 7 with outer wall 5 of valve stem guide 6. This line contact 7 extends only over a part of the total length of retaining member 2. This section, which contacts wall 5 of valve stem guide 6, is joined up by a clip-like section 11 which increases the spring force of section 4 which directly contacts wall 5.

Sealing element 3 is provided with a sealing lip 12 radially surrounding valve stem 8. This sealing lip is usually designed in such a way that it allows passage of a defined quantity of lubricating oil to provide sufficient lubrication to the valve stem in valve stem guide 6. A second sealing lip 13 of sealing element 3 is in static contact with valve stem guide 6, namely with the end face thereof. To adequately ensure the contact pressure of radial lip 12, sealing element 13 is provided with an annular tension spring 14.

Sealing element 3 is retained by an annular flange 15 located at the upper end of retaining member 2. To facilitate assembly, retaining member 2 is provided with a flared edge 16 facing outward.

What is claimed is:

1. A valve stem seal for combustion engines comprising:
a sealing element made of a polymeric material for contacting a valve stem radially and a valve stem guide axially, and
a sleeve-shaped retaining member for holding the sealing element,
the retaining member including a plurality of wall sections for contacting an outer wall of the valve stem guide, the retaining member defining a polyhedron.

2. The valve stem seal as recited in claim 1 wherein the wall sections are spring forced to contact the outer wall of the valve stem guide.

3. The valve stem seal as recited in claim 1 wherein the retaining member has a triangular cross-sectional shape.

4. The valve stem seal as recited in claim 1 wherein the wall sections contacting the outer wall of the valve stem guide have a planar shape.

5. The valve stem seal as recited in claim 1 wherein the retaining member includes further wall sections located between the wall sections, the further wall sections defining arcs and the wall sections having a planar shape, the arcs of the further wall sections defining a center axis coinciding with an axis of the valve stem.

6. The valve stem seal as recited in claim 5 wherein the further wall sections run parallel to the axis of the valve stem over an entire length of the further wall sections.

7. The valve stem seal as recited in claim 1 wherein the wall sections are planar and connect to a section of the retaining member, the section being clip-like in cross-section.
